(19) United States
(12) Patent Application Publication
(10) Pub. No.: US 2009/0039311 A1
(43) Pub. Date: Feb. 12, 2009

(54) DIFLUORIDE COMPOSITION, METHOD OF PREPARATION, AND USE FOR FROSTING GLASS

(75) Inventors: Yves BESSOLES, Castres (FR); Hugues Xavier DE ROULHAC, Boulogne Billancourt (FR); Gerard TROUVE, Castres (FR)

Correspondence Address: YOUNG & THOMPSON, 209 Madison Street, Suite 500, ALEXANDRIA, VA, 22314, US

(73) Assignee: SOCIETE D'EXPLOITATION DES PRODUITS POUR LES INDUSTRIES CHIMIQUES SEPPIC

(21) Appl. No.: 12/250,712

(22) Filed: Oct. 14, 2008

Related U.S. Application Data
(62) Division of application No. 11/288,666, filed on Nov. 29, 2005.

(30) Foreign Application Priority Data
Dec. 10, 2004 (FR) 04/52925

(51) Int. Cl. C09K 13/00

(52) U.S. Cl. 252/79.1

(57) ABSTRACT

A composition with no water consisting essentially of at least one fluoride-ion-generating agent and at least one viscosity modifier, characterized in that its viscosity, measured at 25° C. using a Brookfield™ LVT viscometer fitted with a No. 1 spindle rotating at a speed of 30 revolutions per minute, is between 50 and 5000 mPa·s Method for preparing the composition, dry composition and method of frosting flat glass.

This application is a divisional application of Ser. No. 11/288,666, filed Nov. 29, 2005, currently pending, which claims priority to French Application No. 04/52925, filed Dec. 10, 2004. The teachings of the above applications are hereby incorporated by reference. Any disclaimer that may have occurred during prosecution of the above referenced applications is hereby expressly disclaimed.

### BACKGROUND

The invention relates to novel chemical compositions, to the method for preparing them and to their use for frosting glass.

The action of frosting a sheet of glass makes it translucent, without being transparent, introducing opacity by modifying its surface finish. This action results in a multitude of asperities a few microns in depth, the macroscopic appearance of the surface thus treated then differing depending on the morphology of these asperities. This therefore results in what is called gloss frosted glass, matt frosted glass, opaque glass and translucent glass.

Frosting is generally carried out by sandblasting the surface, when this is of large area, by depositing a thin film or by chemical etching. The latter method is more particularly used on small areas or on objects of relatively complicated shape. Chemical etching is carried out using fluoride ions, which react with the silicon ions of the glass. The glass object is immersed, from a few seconds to a few minutes, either in a concentrated hydrofluoric acid bath or in an acid bath containing a fluoride-ion initiator, such as ammonium difluoride. The glass is then rinsed with water.

The examples of known glass-frosting compositions include: the one disclosed in the German patent published under No. 1596961, which contains hydrofluoric acid and ammonium hydrogen fluoride, called hereafter ammonium difluoride, and water; the one disclosed in the British patent published under No. 1 276 550, which comprises hydrofluoric acid, a water-soluble fluoride, such as ammonium difluoride, and one or more aliphatic carboxylic acids containing one to three carbon atoms, which may or may not be substituted with radicals containing one or more halogen atoms or hydroxy or amino groups, such as formic acid, acetic acid, propionic acid, monochloroacetic acid, trichloroacetic acid and glycolic acid; and the composition disclosed in the Russian patent published under No. SU 1 675 244, comprising hydrofluoric acid, ammonium difluoride, sodium fluorosilicate, potassium fluorosilicate and water. The Applicant has also developed a novel composition based on potassium difluoride and hydrochloric acid, limiting the emission of ammonia, which has been disclosed, together with its use for glass objects, in European patent applications EP 1 108 773 and EP 1 160 213.

The combination of a difluoride containing an alkali or alkaline-earth metal cation with a strong acid improves both the effectiveness of the chemical etching and the appearance of the frosted glass obtained. When it is intended more specifically to frost flat glass, there are generally surfaces of large area to be treated. This requires storing large volumes of concentrated acids that are toxic and corrosive, such as hydrochloric, sulphuric and hydrofluoric acids, and leads to the production of large amounts of undesirable effluents.

It is for this reason that there is a need at the present time to develop novel compositions that can be used without employing concentrated acids.

### SUMMARY OF THE INVENTION

The inventors have developed a novel method of frosting glass that is particularly suitable for frosting flat glass and does not have the abovementioned drawbacks.

According to a first aspect, the subject of the invention is an aqueous composition comprising at least one fluoride-ion-generating agent and at least one viscosity modifier, characterized in that its viscosity, measured at 25° C. using a Brookfield™ LVT viscometer fitted with a No. 1 spindle rotating at a speed of 30 revolutions per minute, is between 50 and 5000 mPa·s.

### DETAILED DESCRIPTION OF THE INVENTION

The term “fluoride-ion-generating agent” is understood in general to mean water-soluble difluoride compounds.

The term “water-soluble difluoride compound” is understood within the present patent application to mean either a compound or a mixture of compounds.

These compounds are more particularly chosen from sodium difluoride (NaHF₂), potassium difluoride (KHF₂) and ammonium difluoride (NH₄HF₂) or a mixture of two or all of these three salts. When the composition as defined above comprises a mixture of two or three difluoride compounds among which is potassium difluoride, the latter preferably represents at least 50% by weight of the said mixture. When the composition as defined above comprises a mixture of two or three difluoride compounds among which is ammonium difluoride, the latter preferably represents at most 15% by weight and most particularly at most 5% by weight of the said mixture.

The composition as defined above may further include an insoluble filler. This is more particularly chosen from: baryte; gypsum; insoluble fluoride salts, and more particularly calcium fluoride; insoluble fluorosilicates, and more particularly calcium fluorosilicate, potassium fluorosilicate and sodium fluorosilicate; calcium phosphate; calcium sulphate; mineral oxides, in particular iron, zinc, aluminium and titanium oxides; lignin; starch; high-molecular-weight ethylene oxide polymers, propylene oxide polymers and butylene oxide polymers; fatty acids and their derivatives that are solid at room temperature; high-molecular-weight insoluble polymers and resins. The composition forming the subject of the present invention may include one or more fillers as defined above.

The composition as defined above may further include a surfactant. This is more particularly chosen from wetting agents and/or suspension agents, in particular from alkoxylated fatty alcohols, phosphated fatty alcohols, phosphated alkoxylated fatty alcohols, acrylic derivates, ethylene oxide/propylene oxide copolymers, fatty amides, or cationic surfactants or fluoride derivatives of the said surfactants, and silicone or fluorosilicone surfactants. The composition forming the subject of the present invention may include one or more surfactants as defined above.

The composition as defined above may further include a water-soluble salt. This is more particularly chosen from salts containing alkali metal cations, salts containing divalent cations and salts containing trivalent cations and more particularly from calcium, magnesium, zinc, iron and aluminium salts. Examples of these are sodium chloride, manganese chloride, magnesium chloride, magnesium sulphate, calcium chloride and ferric chloride. The composition forming the subject of the present invention may include one or more water-soluble salts as defined above.

The term “viscosity modifier” is understood within the present invention to mean any agent, in the proportions defined above, capable of providing the composition forming the subject of the present invention with the rheology suitable for the desired use by giving it good flow properties so as to spread over the surface of the glass. Thanks to this viscosity modifier, the composition as defined above has a viscosity, measured at 25° C. using a Brookfield™ LVT viscometer fitted with a No. 1 spindle rotating at a speed of 30 revolutions per minute, that is between 50 and 5000 mPa·s, more particularly between 50 and 3000 mPa·s and between 100 and 1000 mPa·s. The viscosity of the composition as defined above may also be characterized by a flow time, measured with cup No. 4 according to the NFT 30-014 standard, of between 10 and 60 seconds, preferably between 14 and 30 seconds.

The viscosity modifier is more particularly chosen from cellulose polymers, such as, for example, methyl cellulose, ethyl cellulose, hydroxyethyl cellulose, hydroxypropyl cellulose, hydroxypropylmethyl cellulose or carboxymethyl cellulose, and natural gums and is preferably a xanthan gum or a guar gum. Examples of commercial xanthan gums are Rhodopol™ 23 and Kelzan™. An example of a commercial guar gum is Jaguar™ HP. The composition forming the subject of the present invention may include one or more viscosity modifiers as defined above.

The subject of the invention is more particularly a composition characterized in that it consists essentially, per 100% of its weight, of:
0.025% to 1.25% by weight of at least one viscosity modifier;
10% to 49.975% by weight of at least one water-soluble difluoride compound;
0% to 39.975% by weight of a water-insoluble filler;
0% to 5% of at least one surfactant;
0% to 39.975% by weight of at least one water-soluble salt; and
50% to 75% by weight of water;
   and most particularly a composition as defined above, characterized in that it consists essentially, per 100% of its weight, of:
0.1% to 1% by weight of at least one viscosity modifier;
25% to 40% by weight of at least one water-soluble difluoride compound;
5% to 15% by weight of a water-insoluble filler;
0% to 5% of at least one surfactant;
0% to 5% by weight of at least one water-soluble salt; and
50% to 75% by weight of water.

According to another aspect, the subject of the invention is a method of preparing a composition as defined above, characterized in that the fluoride-ion-generating agent, the viscosity modifier, in an amount sufficient to achieve the desired viscosity, and the optional insoluble filler, surfactant and/or water-soluble salt are mixed, with stirring, with water.

According to another aspect, the subject of the invention is a method of preparing a composition as defined above, characterized in that the following are mixed, with stirring, in order to obtain 100% of its weight:
25% to 50% by weight of a composition with no water, consisting essentially, per 100% of its weight, of:
   0.05% to 5% by weight of at least one viscosity modifier,
   20% to 99.95% by weight of at least one water-soluble difluoride compound,
   0% to 79.95% by weight of a water-insoluble filler and
   0% to 20% of at least one water-soluble salt;
with 50% to 75% by weight of water.

The water used to prepare the composition forming the subject of the present invention is generally town supply water, the temperature of which varies from about 10° C. to 30° C.

The composition with no water used in the method defined above also constitutes one particular aspect of the present invention.

The expression “with no water” means that the composition contains no added water and that any water that is present is substantially only water of inclusion present in one or other of the constituent salts. In any case the expression “with no water” means a composition comprising less than 5% water by weight and preferably less than 1% water by weight.

The composition with no water as defined above is in the form of powders, granules, pellets or cakes.

More particularly, it consists, per 100% of its weight, essentially of:
0.2% to 4% by weight of at least one viscosity modifier,
50% to 80% by weight of at least one water-soluble difluoride compound,
10% to 30% by weight of a water-insoluble filler and
0% to 20% of at least one water-soluble salt.

The aqueous frosting composition forming the subject of the present patent application may also be prepared by introducing each of its components into water, with stirring. The stirring is continued until a homogeneous composition is obtained and until the temperature of the preparation returns to around the ambient temperature, i.e. about 12° C. to about 25° C.

According to a final aspect, the subject of the invention is a method of frosting precleaned or prescoured glass, characterized in that it includes a step (a) during which the surface of the glass object is brought into contact, for between 2 and 20 minutes, preferably between 2 and 10 minutes, with the solution as defined above. This step (a) is generally followed by a step (b) of rinsing the frosted object with water and then, if desired, by a step (c) of drying the object thus rinsed. During steps (a) and (b), the frosting and rinsing compositions may either be quiescent or stirred by any known mechanical means, namely propeller stirrers, blade stirrers, brushes, circulating pumps, etc.

The following examples illustrate the invention without however limiting it.

### EXAMPLES

### Example 1 (Invention)

(a) A dry powder blend was prepared in a Turbosphere™ powder blender from the following:

| Components | Percentage by weight |
|---|---|
| Ammonium difluoride | 73% |
| Barium sulphate | 21% |
| Sodium chloride | 1.5% |
| Calcium chloride | 3.5% |
| Rhodopol ™ 23 | 1% |

This blend took the form of a white free-flow powder.
(b) 1 kg of this blend was poured into 1.5 kg of town supply water at 25° C., with slow stirring at 450 revolutions per minute by means of a propeller stirrer. The stirring was maintained for 20 hours so that the temperature of the bath stabilized at around 25° C. A perfectly homogeneous bath having a viscosity of 520 mPa·s, measured using a Brookfield™ LVT viscometer fitted with a No. 1 spindle rotating at a speed of 30 revolutions per minute, and a flow time of 20 seconds, measured with cup No. 4 according to the NFT 30-014 standard, was obtained. This bath was stable, with no sedimentation.
(c) About 1 kg of this bath was poured into a plastic tank in which a glass plate 2500 cm² in area had been deposited, one of the faces of which was protected by a plastic film. After 8 minutes of immersion, the glass plate was removed from the bath and liberally rinsed with tap water at 15° C. for 2 minutes, then left to dry in air and the plastic film was removed.

A plate frosted on one face with a perfectly uniform and defect-free appearance was obtained. The frosting consisted of “rounded pyramids” on the surface of the glass, these having a mean height of about 10 μm and a width of 30 μm to 50 μm. The glass left no fingerprints when it was handled.

### Example 2 (Invention)

(a) Poured in succession into 1.3 litres of town supply water at 25° C., maintained with slow stirring at 450 revolutions per minute by means of a propeller stirrer, were 730 g of ammonium difluoride, 260 g of calcium fluoride and 10 g of standard Kelzan. The stirring was maintained for 24 hours so that the temperature of the bath stabilized at around 25° C. A perfectly homogeneous bath having a viscosity of 1000 mPa·s, measured using a Brookfield™ LVT viscometer fitted with a No. 1 spindle rotating at a speed of 30 revolutions per minute, and a flow time of 34 seconds, measured with cup No. 4 according to the NFT 30-014 standard, was obtained. This bath was stable, with no sedimentation.
(b) About 1 kg of this bath was poured into a plastic tank in which a glass plate 200 cm² in area had been deposited, one of the faces of which was protected by a plastic film. After 10 minutes of immersion, the glass plate was removed from the bath and liberally rinsed with tap water at 15° C. for 2 minutes, then left to dry in air, and the plastic film was removed.

A plate frosted on one face with a perfectly uniform and defect-free appearance was obtained. The frosting consisted of “rounded pyramids” on the surface of the glass, these having a mean height of about 9 μm and a width of 30 μm to 50 μm. The glass left no fingerprints when it was handled.

### Example 3 (Prior Art)

(a) The experiment of Example 2 was repeated with a frosting bath not containing the Kelzan thickener. What was obtained was a bath that rapidly sedimented and, unlike the solutions according to the invention, had to be maintained with stirring. Its viscosity was about 5 mPa·s, measured using a Brookfield™ LVT viscometer fitted with a No. 1 spindle rotating at a speed of 30 revolutions per minute. Its flow time measured in an AFNOR No. 4 cup was 9 seconds.
(b) About 1 kg of this bath was poured into a plastic tank in which a glass plate 200 cm² in area had been deposited, one of the faces of which was protected by a plastic film. After 3 minutes of immersion, the glass plate was removed from the bath and liberally rinsed with tap water at 15° C. for 2 minutes, then left to dry in air, and the plastic film was removed.

A frosted plate of non-uniform appearance, formed from “shallow pyramids” (about 4 to 5 μm in depth) was obtained, the shapes of the pyramids being less rounded than in the previous example. This surface structure left pronounced fingerprints when the glass was handled.

Comparing Example 2 with Example 3 shows that the compositions according to the invention have an advantage in terms of frosting quality compared with those of the prior art. This advantage is obtained without adding a strong acid to the solution.

### Example 4 (Invention)

(a) A dry blend was prepared in a powder blender from the following:

| Components | Percentage by weight |
|---|---|
| Ammonium difluoride | 75% |
| Filler 1: barium sulphate | 12% |
| Filler 2: titanium dioxide | 12% |
| Surfactant: alkyl phosphate | 0.1% |
| Thickener: guar gum | 0.9% |

This blend took the form of a white free-flow powder.
(b) 10 kg of this blend were poured into 15 kg of town supply water at 20° C. with rapid stirring at 1000 revolutions per minute by means of a deflocculation blade. The stirring was maintained for 2 hours and then the bath was left at rest until the temperature of the bath stabilized at around 17° C. A perfectly uniform white bath was obtained, characterized by a flow time of 20 seconds measured using cup No. 4 according to the NFT 30-014 standard. This bath was stable, with no sedimentation.
(c) About 10 kg of this bath were poured into a plastic tank in which a glass plate measuring 80×80 cm had been deposited, one of the faces of which was protected by a plastic film. After 8 minutes of immersion, the glass plate was removed from the bath, its surface was scraped by means of a rubber blade, then liberally rinsed with hot water and finally left to dry in air, and the plastic film was removed.

A plate frosted on one face with a perfectly uniform and defect-free appearance was obtained. The frosting consisted of micron-scale “pyramids” uniformly distributed on the surface of the glass. The glass left no fingerprints when it was handled.

### Example 5 (Invention)

(a) A frosting bath containing no insoluble filler was produced by dispersing in succession, in 3 litres of water, 1440 g of ammonium difluoride and 20 g of guar gum. The mixture was stirred by means of a deflocculation blade until a homogeneous bath was obtained. The composition by weight of the bath obtained was:

| Components | Percentage by weight |
|---|---|
| Ammonium difluoride | 32.3% |
| Guar gum | 0.4% |
| Water | 67.3% |

This bath was characterized by a flow time measured using an AFNOR No. 4 cup of 15 seconds.
(b) A glass plate was immersed for 8 minutes in this bath and then rinsed. It then had a uniform frosted appearance. Examined under the microscope, its surface was in the form of a juxtaposition of “pyramids” having dimensions in the region of about 30 to 50 μm.

What is claimed is:

1. A composition with no water, said composition consisting essentially of, per 100% of its weight:
a) 0.05 to 5% by weight of at least one viscosity modifier;
b) 20 to 99.95% by weight of at least one water-soluble difluoride compound;
c) 0 to 79.95% by weight of a water-insoluble filler; and
d) 0 to 20% of at least one water-soluble salt.

2. The composition of claim 1, wherein said composition consists essentially of, per 100% of its weight:
a) 0.2 to 4% by weight of said at least one viscosity modifier;
b) 50 to 80% by weight of said at least one water-soluble difluoride compound;
c) 10 to 30% by weight of said water-insoluble filler; and
d) 0 to 20% of said at least one water-soluble salt.
